(19) United States
(12) Patent Application Publication
(10) Pub. No.: US 2006/0168347 A1
(43) Pub. Date: Jul. 27, 2006

(54) System for sharing context information between executable applications

(76) Inventor: Eric Martin, Chester Springs, PA (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/180,354

(22) Filed: Jul. 13, 2005

Related U.S. Application Data
(60) Provisional application No. 60/634,790, filed on Dec. 9, 2004.

(51) Int. Cl. G06F 15/16

(52) U.S. Cl. 709/246

(57) ABSTRACT

A system permits client integration of two applications using complex integration points providing bidirectional transfer of contextual information enabling application integration. A system minimizes a need for application specific coding to support executable application interoperability by incorporating a mediation function enabling user configurable interception and substitution of commands, context information and data exchanged between different applications. A system supporting concurrent operation of multiple different executable applications includes a source of command configuration data for use in identifying, a command type, a location of context data in a command of a particular type and a destination executable application for receiving a command of a particular type. A mediation processor receives a first command from a first executable application and uses the configuration data in, identifying a command type of the first command, locating context data in the first command and formatting a second command to include the located context data to be compatible with a destination executable application.

This is a non-provisional application of provisional application Ser. No. 60/634,790 by E. Martin filed Dec. 9, 2004.

### FIELD OF THE INVENTION

This invention concerns a system for exchanging commands, data and context information to support concurrent operation of different executable applications.

### BACKGROUND OF THE INVENTION

Operational integration of different executable applications is necessary to enable concurrent operation of applications supporting functions accessed via corresponding image windows in a composite single displayed image, for example, as well as in a variety of other circumstances. Operational integration enables a first application to pass commands and data to a destination application to initiate required functions. One existing system uses an interoperability communication protocol for common use by the different executable applications for exchanging commands and data. The common use of such an interoperability protocol typically means that the different executable applications individually employ code to support use of the interoperability protocol. However, an additional application that does not support the protocol needs modification to incorporate code to enable operational integration with existing applications using the interoperability protocol. Further, the additional application may need to be modified to incorporate code to enable operational integration for multiple different types of command and data interchange. The need to provide such application specific code represents a substantial burden on personnel resources and involves risk of error and delay. A system according to invention principles addresses this problem and associated problems.

### SUMMARY OF INVENTION

A system minimizes a need for application specific coding to support executable application interoperability by incorporating a mediation function enabling user configurable interception and substitution of commands, context information and data exchanged between different applications. A system supporting concurrent operation of multiple different executable applications includes a source of command configuration data for use in identifying, a command type, a location of context data in a command of a particular type and a destination executable application for receiving a command of a particular type. A mediation processor receives a first command from a first executable application and uses the configuration data in, identifying a command type of the first command, locating context data in the first command and formatting a second command to include the located context data to be compatible with a destination executable application.

### BRIEF DESCRIPTION OF THE DRAWING

FIG. 1 shows an Internet compatible Host system supporting interoperability of different executable applications, according to invention principles.

FIG. 2 shows configuration information employed by a user configurable mediation function enabling application interoperability, according to invention principles.

FIG. 3 illustrates operational integration of a medical device application and a clinical information system application using a configurable mediation function, according to invention principles.

FIG. 4 shows a flowchart of a process supporting interoperability of different executable applications, according to invention principles.

### DETAILED DESCRIPTION OF THE INVENTION

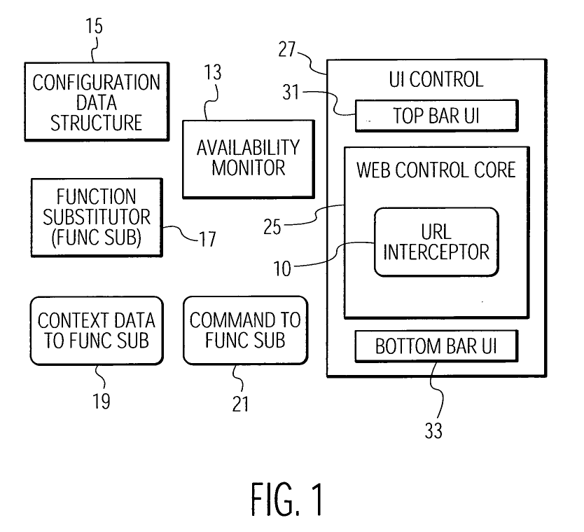

FIG. 1 shows an Internet compatible Host system supporting interoperability of different executable applications. A system supports executable application interoperability by using a mediation function enabling user configurable interception and substitution of commands, context information and data. Commands including substitute data are generated for bidirectional or unidirectional exchange between different applications without requiring specific application coding. An intercepted and generated substitute command enables integration between different applications and exchange of a particular command type and associated context information or data between different applications. A specific instance of command interchange (command integration) between different applications is a particular integration point comprising a particular command and data interchange link between two concurrently operating different executable applications having a particular command type and associated context information or data. The system advantageously permits such integration to be configured rather than coded.

The system advantageously avoids the need for specific coding to support integration by intercepting an input command (stimulus) from a first application and evaluating whether the input command is a particular command type supporting an integration point. The system extracts contextual information from the input command and identifies a function configured for this integration point. The system accesses a function definition associated with the identified function and substitutes both the contextual information extracted from the intercepted input command and globally configured values into the function definition to provide a resultant output command for communication to a destination application. Global values comprise one or more individual data items substituted into multiple different commands such as a URL address portion (a base URL) or other items that are incorporated into multiple different commands.

The system supports maintenance of integration points by enabling change to configuration of function definitions (output command formats) without requiring change to specific application code of executable applications involved. A mediation processor in the system performs function (command) substitution using a consistent definition of functions (commands) retained in a configuration file. The system mediation processor processes input commands configured to be one of multiple predetermined command types. Command types may include URLs, GSM encoded URLs, and user interface commands or events, for example. An embodiment of the system involves defining an input command, intercepting a defined command from a first application and evaluating whether the intercepted command is configured to act as an integration point. The system extracts contextual information from an intercepted input command in response to predetermined configuration information using extractors (executable procedures) that may be specific to a command type, for example. Available contextual information is substituted into the function which is configured for this integration point to provide an output command for communication to a destination application. Additional contextual information including globally available values such as a base URL, for example, is derived from a configuration file and also incorporated into the function configured for the integration point. An output command format may comprise a URL, a GSM encoded URL, a user interface event, a JavaScript function call and an ActiveX interface call, for example.

An executable application as used herein comprises code or machine readable instruction for implementing predetermined functions including those of an operating system, healthcare information system or other information processing system, for example, in response user command or input. An executable procedure is a segment of code (machine readable instruction), sub-routine, or other distinct section of code or portion of an executable application for performing one or more particular processes and may include performing operations on received input parameters (or in response to received input parameters) and provide resulting output parameters. A processor as used herein is a device and/or set of machine-readable instructions for performing tasks. A processor comprises any one or combination of, hardware, firmware, and/or software. A processor acts upon information by manipulating, analyzing, modifying, converting or transmitting information for use by an executable procedure or an information device, and/or by routing the information to an output device. A processor may use or comprise the capabilities of a controller or microprocessor, for example. A display processor or generator is a known element comprising electronic circuitry or software or a combination of both for generating display images or portions thereof. A user interface comprises one or more display images enabling user interaction with a processor or other device. A source of command configuration data comprises a file, repository, database or other compilation of data.

In the FIG. 1 Internet compatible system a user interface application 27 initiates generation of data representing images for display on a reproduction device (not shown) in response to user command. The FIG. 1 system is described herein in the context of an Internet compatible system processing URL commands. However, it is to be understood this is for exemplary purposes only. The system and invention principles operate to support concurrent operation of Internet compatible or non-Internet compatible executable applications employing non-URL commands. The display images are associated with concurrently executable applications invoked in response to user command. An individual display image may include a single composite image including multiple windows individually showing information associated with corresponding multiple concurrently operated executable applications. The displayed images include a browser frame providing user selectable buttons, option lists and data entry boxes in user interface menu bars 31 and 33, for example, enabling user entry of commands and other data for configuring and operating the system.

Application 27 incorporates an Internet compatible application 25 including mediation function (processor) 10 enabling user configurable interception of an input command associated with a particular integration point. The particular integration point comprises a particular command and data interchange link between two concurrently operating different executable applications having a particular command type and associated context information or data. Mediation processor 10 provides user configurable extraction of contextual information from the input command and substitution of available contextual information (including the extracted contextual information and globally configured data) into a command associated with the particular integration point. A user configuration function employs predetermined data structuring configuration file 15 and command substitution configuration file 17. Configuration files 15 and 17 associate multiple integration points with corresponding multiple command types and with corresponding command type specific information including data comprising, command structure information, data substitution information, data indicating a destination executable application for receiving a command of a particular type, information indicating location of context data in a command of a particular type, contextual information and command data.

Mediation processor 10 identifies a command type of an input command and availability monitor processor 13 uses predetermined data structuring configuration file 15 and command substitution configuration file 17 to determine if the identified command type of the input command is associated with the particular integration point. If monitor 13 determines the identified command type of the input command is associated with the particular integration point, mediation processor 10 employs data in configuration files 15 and 17 to locate context data in the input command. Mediation processor 10 uses context data substitution function 19 and command substitution function 21 to format an output command to include the located context data and to be compatible with a destination executable application and initiates communication of the output command to the destination executable application.

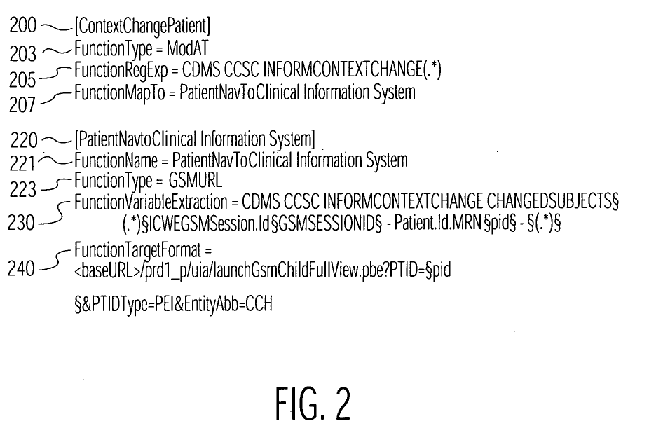

FIG. 2 shows configuration information as used in configuration files 15 and 17 employed by user configurable mediation function (processor 10) enabling application interoperability. The configuration information is used by mediation processor 10 to intercept an input command from a first executable application such as a user interface application and to extract contextual information from the input command as well as to substitute the contextual information into a formatted output command and to communicate the output command to a Clinical Information System application, for example. In operation of a clinical information system, the configuration information of FIG. 2 is used to update displayed clinical information of a first patient in a first window of a composite display image. Specifically, it updates the displayed clinical information shown in the first window associated with a first application to include clinical information of a different user selected second patient derived using a different destination application.

The ContextChangePatient configuration data 200 (including FunctionType 203, FunctionRegExp 205 and FunctionMapTo 207 elements) is used by mediation processor 10 to identify whether an input command is a predetermined particular type. If processor 10 determines the input command is of a predetermined particular type, processor 10 initiates PatientNavToClinical Information System function 220. The PatientNavToClinical Information System function 220 (including FunctionName 221 and FunctionType 223 elements) is implemented as a distinct stand alone function so that it may be used by multiple input commands. The FunctionVariableExtraction 230 determines how to extract contextual information from the input command. The FunctionTargetFormat 240 determines the structure of an output command and employs a global variable (baseURL). The FunctionType 203 expression is used in the FIG. 2 configuration information to determine command type.

In exemplary operation, an individual composite display image generated in response to command from application 27 (FIG. 1) includes two windows individually showing information associated with a first executable application and a destination executable application. The first executable application and destination executable application are concurrently operating applications sharing a particular integration point comprising a particular command and data interchange link having a particular command type and associated context information or data. A command is initiated in the first application to access clinical information of a particular patient from the destination application using particular patient identifier data context information provided by the first application, for example.

In response to a user input command to initiate a destination application function by selection of an image element (e.g., a hyperlink) in a window associated with the first application, the first application initiates generation of a command and communication of the generated command to the destination application. Mediation processor 10 determines if the generated command is of a particular type and formatted in accordance with predetermined requirements of FunctionRegExp 205 (FIG. 2) in the ContextChangePatient section 200. FunctionRegExp 205 specifically includes information about changed context subjects such as CDMS CCSC INFORMATIONCONTEXTCHANGE CHANGEDSUBJECTS Patient.Id.MRN-1343123, for example.

In response to a determination the generated command is compatible with requirements of FunctionRegExp 205, mediation processor 10 intercepts the generated command from the first executable application, determines that the intended recipient is a destination executable application and inhibits further propagation of the intercepted command. Mediation processor 10 locates and extracts context information from the intercepted command using FunctionVariableExtraction 230 configuration data in the PatientNavToClinical Information System section 220. Further, mediation processor 10 generates a second command for communication to the destination executable application using the formatting indicated by the FunctionTargetFormat 240 configuration data. The generated second command includes the located and extracted context data derived from the intercepted command. Mediation processor 10 communicates the generated second command to the destination executable application. The destination executable application processes the second command by performing an action required by the second command using the context information provided with the second command.

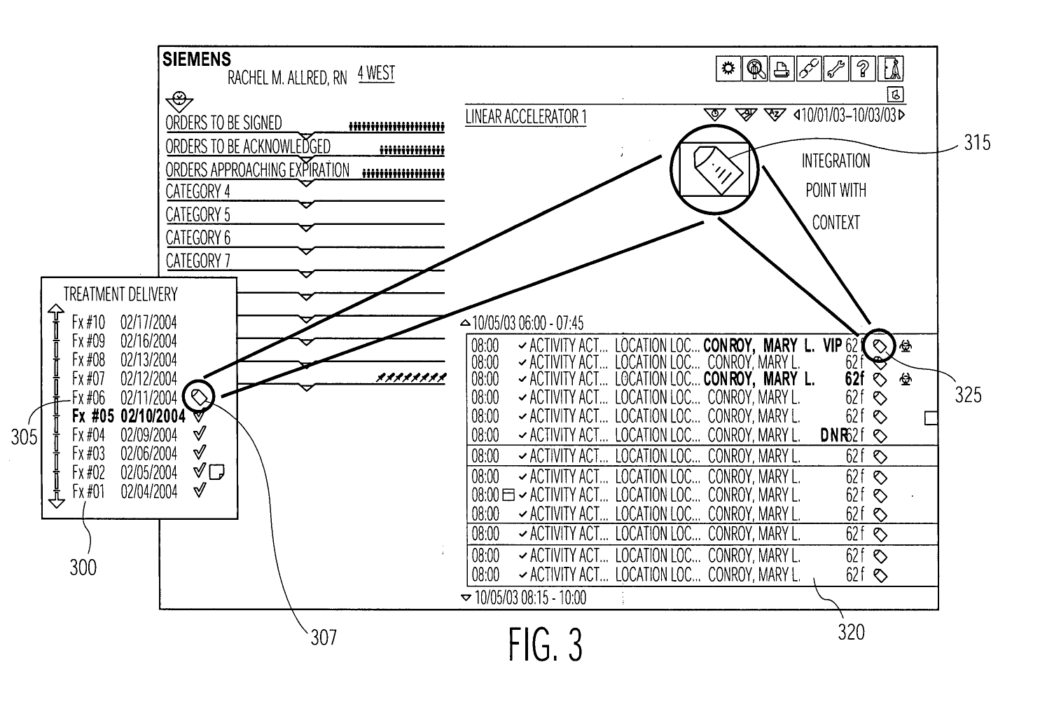

FIG. 3 illustrates operational integration of a first medical device application and a different destination clinical information system application using a configurable mediation function. Mediation processor 10 intercepts data representing an input command and associated context information initiated via composite user interface image window 300 in response to user selection of icon 307 associated with a radiation treatment episode of Feb. 11, 2004 on row 305. Mediation processor 10 determines that an integration point (illustratively indicated as item 315) is associated with the input command using configuration data in configuration files 15 and 17. Processor 10 further generates a command incorporating context data derived from the input command for communication to a destination (Workspace) application associated with image window 320 and presenting icon 325 indicating accessible information of the first application.

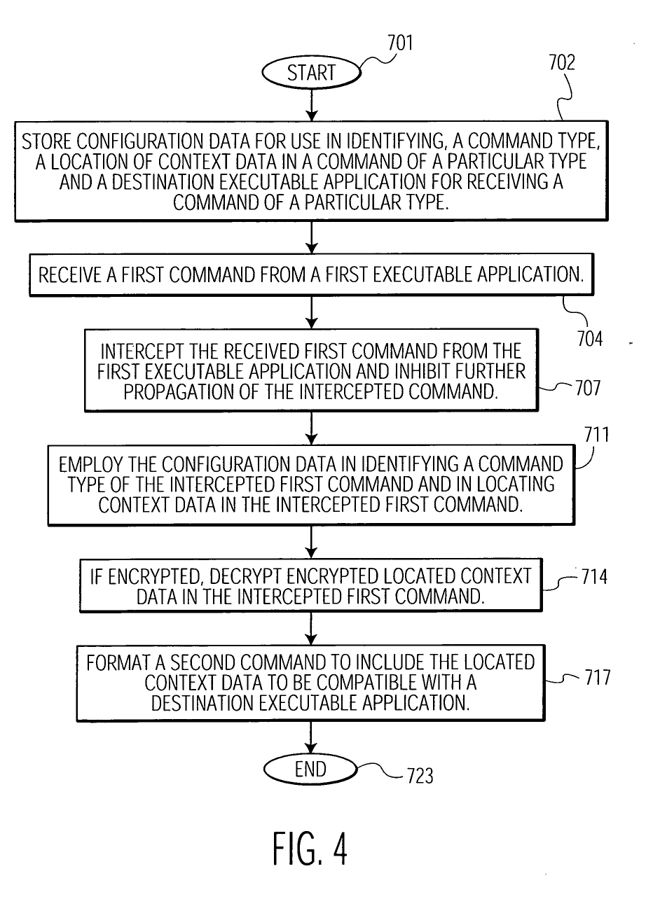

FIG. 4 shows a flowchart of a process performed by mediation processor 10 in conjunction with other units of the FIG. 1 system enabling interoperability of concurrently operating different executable applications. In step 702 following the start at step 701, configuration data is stored in configuration files 15 and 17. The stored configuration data is usable for identifying, a command type, a location of context data in a command of a particular type, a destination executable application for receiving a command of a particular type and a command format required by the destination executable application. The context data comprises one or more of, a patient identifier, a patient medical record number, a userid, a password, a medical image identifier, patient contact information, patient address information, patient insurance information, patient treatment information, patient treatment order information and patient healthcare provider identification information. The command type comprises a URL command type for use in acquiring patient specific medical information. The command type may alternatively comprise a non-URL command type.

Mediation processor 10 in step 704 receives a first command from a first executable application. In step 707, mediation processor 10 intercepts the received first command from the first executable application and inhibits further propagation of the intercepted command. Mediation processor 10 in step 711 employs data in configuration files 15 and 17 in identifying a command type of the intercepted first command and in locating context data in the intercepted first command. In step 714, mediation processor determines whether the located context data is encrypted. If the context data is encrypted, mediation processor 10 decrypts the encrypted located context data. If the first command is a URL, mediation processor 10 locates the encrypted context data in a data field of the URL. Mediation processor 10 in step 717 formats a second command to include the located (and optionally decrypted) context data to be compatible with a required command format of a destination executable application. In one embodiment, the second command is a URL and mediation processor 10 (using functions 19 and 21 of FIG. 1) formats the second command by encrypting the located context data for inclusion in the second command in a data field of the URL for communication to the destination executable application. In another embodiment the context data is included in non-encrypted form in the second command. The process of FIG. 4 terminates at step 723. The system minimizes any need for specific integration point associated coding for supporting interoperability of applications and allows details of the integration point to be maintained without requiring coding changes by the involved applications. The system supports integration of medical devices and IT applications.

The system minimizes need for specific coding (and the maintenance of code) of at least one of the involved concurrently operating applications. The system capability to provide and maintain integration points between multiple applications is applicable to a wide variety of applications and environments. The system, process and user interface display image presented herein are not exclusive. Other systems and processes may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. Further, any of the functions provided by the system and process of FIGS. 1 and 4, may be implemented in hardware, software or a combination of both.

What is claimed is:

1. A system supporting concurrent operation of a plurality of different executable applications, comprising:
a source of command configuration data for use in identifying,
a command type,
a location of context data in a command of a particular type and
a destination executable application for receiving a command of a particular type; and
a mediation processor for receiving a first command from a first executable application and for using said configuration data in,
identifying a command type of said first command,
locating context data in said first command and
formatting a second command to include said located context data to be compatible with a destination executable application.

2. A system according to claim 1, wherein
said source of command configuration data is used for identifying a command format required by said destination executable application and
said mediation processor uses said configuration data in formatting said second command to be compatible with said required command format of said destination executable application.

3. A system according to claim 1, wherein
said context data comprises at least one of, (a) a patient identifier and (b) a patient medical record number.

4. A system according to claim 1, wherein
said context data comprises at least one of, (a) a userid and (b) a password.

5. A system according to claim 1, wherein
said context data comprises at least one of, (a) medical image identifier, (b) patient contact information, (c) patient address information, (d) patient insurance information, (e) patient treatment information, (e) patient treatment order information and (f) patient healthcare provider identification information.

6. A system according to claim 1, wherein
said mediation processor intercepts said first command from said first executable application and inhibits further propagation of said intercepted command.

7. A system according to claim 1, wherein
said command type comprises a URL command type.

8. A system according to claim 7, wherein
said URL command type is for use in acquiring patient specific medical information.

9. A system according to claim 1, wherein
said command type comprises a non-URL command type.

10. A system according to claim 1, wherein
said mediation processor decrypts encrypted located context data in said first command.

11. A system according to claim 10, wherein
said first command is a URL and
said mediation processor locates said encrypted context data in a data field of said URL.

12. A system according to claim 1, wherein
said mediation processor formats said second command by encrypting said located context data for inclusion in said second command.

13. A system according to claim 12, wherein
said second command is a URL and
said mediation processor formats said encrypted located context data in a data field of said URL.

14. A system according to claim 1, wherein
said mediation processor formats said second command to include a global value comprising an individual data item substituted into multiple different commands.

15. A system according to claim 14, wherein
said individual data item comprises a URL address portion.

16. A system supporting concurrent operation of a plurality of different executable applications, comprising:
a source of command configuration data for use in identifying,
a command type,
a location of context data in a command of a particular type and
a destination executable application for receiving a command of a particular type; and
a mediation processor for intercepting a first command from a first executable application and for using said configuration data in,
identifying a command type of said first command,
locating context data in said first command and
formatting a second command to include said located context data to be compatible with a destination executable application.

17. A method for conveying information between executable applications supporting concurrent operation of said different executable applications, comprising the activities of:
storing configuration data for use in identifying,
a command type,
a location of context data in a command of a particular type and
a destination executable application for receiving a command of a particular type; and
receiving a first command from a first executable application;
using said configuration data in,
identifying a command type of said first command,
locating context data in said first command and
formatting a second command to include said located context data to be compatible with a destination executable application.

18. A system according to claim 17, including the activities of
intercepting said first command from said first executable application and inhibiting further propagation of said intercepted command.
